(19) United States
(12) Patent Application Publication
(10) Pub. No.: US 2002/0121236 A1
(43) Pub. Date: Sep. 5, 2002

(54) Safety hook

(76) Inventor: Bernard Besson, Paris (FR)

Correspondence Address: DRINKER BIDDLE & REATH LLP, One Logan Square, 18th & Cherry Streets, Philadelphia, PA, 19103-6996, US

(21) Appl. No.: 10/071,984

(22) Filed: Feb. 7, 2002

(30) Foreign Application Priority Data
Feb. 8, 2001 (FR) 01 01 688

(51) Int. Cl. F16B 1/00

(52) U.S. Cl. 116/212; 403/2; 403/27; 59/86

(57) ABSTRACT

A hook fitted with a device making it possible to see whether or not it has been subjected to tensile stress is described. The hook is characterised in that it is fitted with a safety ring set in the passage orifice for the line with a certain clearance so as to receive the latter and to support the tensile stress which might be exerted on the hook if the user falls, being maintained in this orifice in a position in which the clearance is essentially located on the side of the tensile stress and is so by means of a gudgeon, having a diameter smaller than the clearance, inserted in a straight end-to-end bore passing through the outwardly turned edges of the safety ring and the body of the hook so that the gudgeon breaks when subjected to tensile stress greater than a predetermined threshold stress.

### FIELD OF THE INVENTION

The present invention relates to a metal hook, in particular of steel, and especially a safety hook for industrial use.

### BACKGROUND OF THE INVENTION

A hook of this type consists of a body essentially in the shape of an open ring which is closed by a pivoting catch elastically loaded into a closed position, enabling it, on the one hand, to be hooked rapidly and securely onto a safety harness with which a user carrying out work at a height is equipped, and, on the other hand, to enable these elements to be rapidly released from one another.

Such a hook could also be used in other applications, such as, by way of example, mountain climbing or pot-holing, without departing from the scope of the invention.

These hooks are common hooking elements that have been extensively used for decades by numerous people, both in their work and for leisure pursuits; in order to guarantee the maximum safety for these users, the authorities have deemed it appropriate to introduce stringent standards such as standard EN 362, to which safety hooks and in particular safety hooks designed for industrial use must conform.

In order to meet these standards, hooks must, in particular, be fitted with a double-locking safety mechanism, so as to rule out any possibility of their inadvertently coming open.

Consequently, various types of safety hooks are currently available on the market which are designed for various uses, and which may be equipped with sliding or screw-fitted safety rings, double clips, etc.

As a rule, such safety hooks have a passage orifice through which a first end of a safety cable or line is passed, particularly in a loop arrangement with a splice; the second end of this line is designed to be tethered to a fixed element in order to retain the user should he fall.

It goes without saying that a hook that has already been subjected to tensile stress of 200 to 300 kg to retain a user will have been rendered more fragile and that, in parallel, the line with which such a hook is fitted does not have the same resistance as a line that has never been used.

For this reason, professionals would like safety hooks to be fitted with systems that would make it possible to spot, easily and rapidly, a hook that has already been subjected to high tensile stress.

### SUMMARY OF THE INVENTION

Accordingly, the objective of the present invention is to propose a safety hook that will meet this expectation.

A hook of this type is characterised in that it is fitted with a safety ring, which is set with a certain clearance in the passage orifice through which the line is passed in order to receive the latter and to support the tensile force which may be exerted on the hook if the user falls, and is maintained in this orifice in a position in which the clearance is essentially located on the side of the tensile stress and is so by means of a gudgeon having a diameter that is smaller than the clearance.

As proposed by the invention, this gudgeon is inserted in a straight end-to-end bore passing through outwardly turned edges of the safety ring and the body of the hook.

This straight end-to-end bore is in fact defined by two bores aligned by displacing the safety ring in the passage orifice for the line, namely, on the one hand, a first bore provided in the outwardly turned edges of the safety ring and, on the other hand, a second bore provided in the body region of the hook disposed adjacent to the passage orifice of the line, which can be held in a sandwich arrangement between these outwardly turned edges.

As proposed by the invention, the gudgeon is specified so that it breaks when subjected to a tensile stress greater than a predetermined threshold force.

After this rupturing, the safety ring is no longer held in a fixed position but is able to move freely in the passage orifice of the line, in particular by rotating, so that the user will be easily able to spot a hook that has already been subjected to tensile stress.

According to another feature of the invention, which makes this identification process even easier, the hook may be provided with a marker system enabling displacement of the safety ring to be visually seen following rupture of the gudgeon.

This visual marker system may be provided in the form of two coloured marks, for example, one on the safety ring and the other at the periphery of the latter on the body of the hook, these two markers being aligned when the safety ring is held by the gudgeon and in any other position once the latter has ruptured.

It should be pointed out that within the context of this disclosure, the term “line” should be interpreted in a very general sense and may refer to any anchoring system, particularly in a wall or attachment of the hook, such as a rope, cable, sling, etc.

### BRIEF DESCRIPTION OF THE DRAWINGS

The characteristic features of the safety hook proposed by the invention will be described in more detail with reference to the appended drawings, in which:

FIG. 1 illustrates a safety hook as proposed by the invention;

FIG. 2 is a view of the hook illustrated in FIG. 1, shown in section along the axis II-II, on an enlarged scale.

### DETAILED DESCRIPTION OF THE DRAWINGS

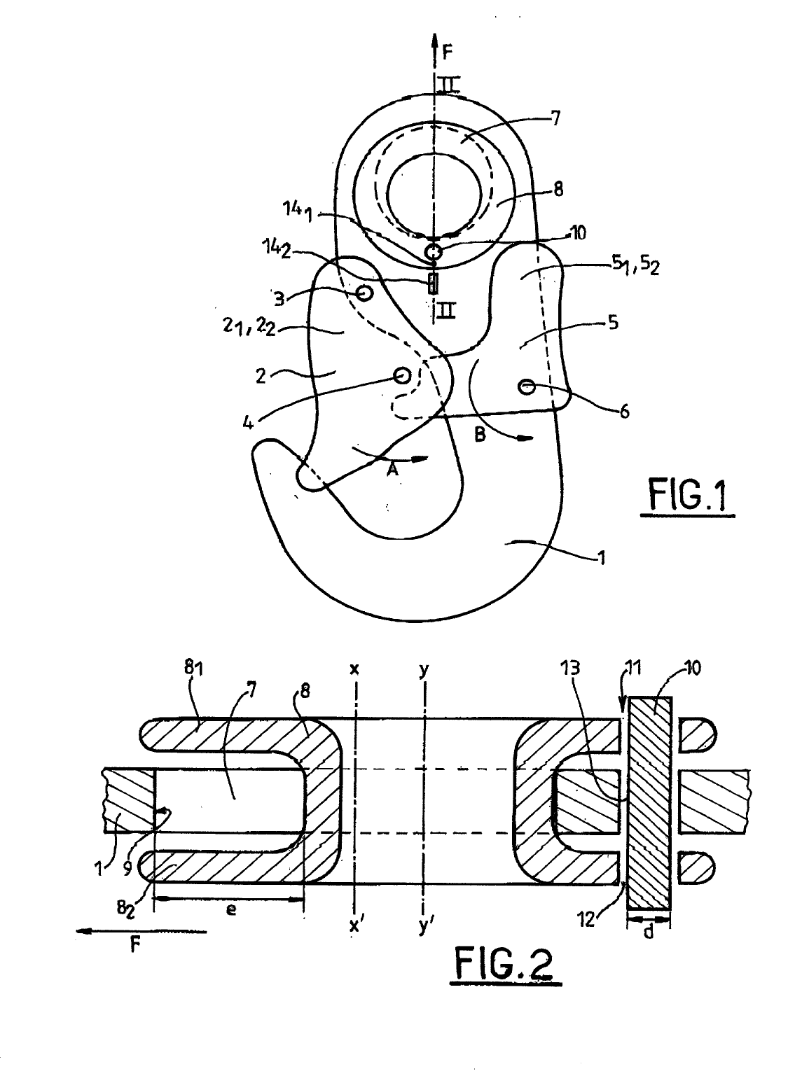

The embodiment of the safety hook illustrated in FIG. 1 has been chosen as an illustrative example only and should not be construed as limiting the invention in any way.

The safety hook in FIG. 1 is made up of a metal body 1 of an essentially open ring shape.

The ring 1 is closed by a catch 2, mounted so as to pivot about a pin 3 and elastically loaded in a closed position as illustrated in FIG. 1 when no external constraint is being applied to it.

In a manner not illustrated in the drawings, the catch 2 is made from a part with a U-shaped section having two parallel sides 2₁, 2₂ between which the body 1 is held in a sandwich arrangement.

The two sides 2₁, 2₂ are joined firstly by the pivot pin 3 inserted through the body 1 in a bore provided therein for this purpose and secondly by a second pin 4 independent of the body 1, the purpose of which will be described below.

As illustrated in FIG. 1, the body 1 of the safety hook is also provided with a ratchet 5 mounted so as to pivot about a pin 6 and elastically loaded in the closed position, as illustrated in FIG. 1, when no external constraint is being exerted on it.

In a manner not illustrated in the drawings, the ratchet 5 is also made from a piece with a U-shaped section having two parallel sides 5₁, 5₂ between which the body 1 is held in a sandwich arrangement.

The two sides 5₁, 5₂ of the ratchet 5 are joined by the pivot pin 6 which passes through the body 1 in a bore provided therein for this purpose.

When in the closed position illustrated in FIG. 1, the pin 4 of the catch 2 moves to bear against the ratchet 5; consequently, the user will not be able to rotate this catch about the pivot pin 3 in the direction of arrow A to open the hook in order, for example, to hook it onto or remove it from a harness.

In order to perform such a manoeuvre, it is necessary to rotate the ratchet 5 about the pivot pin 6 in the direction of arrow B beforehand in order to release the pin 4.

The hook 1 therefore has a double safety feature.

Furthermore, and as illustrated in FIGS. 1 and 2, the hook is provided with a circular orifice 7 with an axis xx′, intended for passing through a first end of a safety line forming a loop, not illustrated, the other end of which is attached to a fixed element.

The purpose of this safety line is to retain the user in the event of a fall, in which case it will exert tensile stress on the hook, indicated by the arrow F.

A safety ring 8 having an axis yy′ is set in a fixed arrangement inside the passage orifice 7 with a clearance e so that its outwardly-turned edges are able to straddle the body 1 of the hook in a region 9 located at the periphery of this passage orifice 7.

This safety ring 8 receiving the line takes the tensile stress F which may be exerted on the hook if the user falls.

As may be seen more specifically in FIG. 2, the safety ring 8 is maintained in the passage orifice 7 by a gudgeon 10 having a diameter d that is smaller than the clearance e.

This gudgeon 10 is inserted in a straight end-to-end bore 11 through the outwardly turned edges 8₁, 8₂ of the safety ring 8 and the body 1 of the hook in the region 9 located adjacent to the periphery of the passage orifice 7.

The bore 11 is defined by an alignment on the one hand of a first bore 12 provided in the outwardly turned edges 8₁, 8₂ of the ring 8 and on the other hand a second bore 13 provided in the region 9 of the body 1 of the hook, which can be held in a sandwich arrangement between these outwardly turned edges 8₁, 8₂.

As illustrated in the drawings, the gudgeon 10 holds the safety ring 8 in a position in which the clearance e is essentially located on the side of the tensile stress F which may be exerted on the hook by a line; this means that the ring 8 will tend to be displaced in the passage orifice 7, under the action of such tensile stress F, by the distance permitted by the clearance e and will be retained only by the gudgeon 10.

Under such circumstances, this gudgeon 10 is therefore subjected to a shearing force, which causes it to rupture on exceeding a predetermined threshold force for which the gudgeon was initially rated.

Following this rupture, the safety ring 8 is no longer held in a fixed position in the passage orifice 7 but is able to move freely in this passage orifice; the user will then immediately be able to see that the hook has already been subjected to tensile stress.

As illustrated in FIG. 1, in order to make such identification easier, the safety ring 8 as well as the part of the hook body 1 located at the periphery thereof are provided with visual markers 14₁, 14₂ which are aligned when the ring is held in position by the gudgeon 10, as illustrated in FIG. 1, and are in any position once this gudgeon has ruptured.

What is claimed is:

1) A safety hook, in particular a hook for industrial use, comprising a body essentially having the shape of an open ring, closed by a pivoting catch elastically loaded in a closed position so that it can be rapidly and securely hooked onto a safety harness with which a user required to perform work at a height is equipped and rapidly released from these elements, the safety hook having a passage orifice through which is passed a first end, particularly disposed in a loop, of a safety rope or line, the second end of which is attached to a fixed element to retain the user in the event of a fall, the safety hook being fitted with a safety ring set in the passage orifice for the line with a certain clearance so as to receive the latter and to support a tensile stress which might be exerted on the hook if the user falls, being maintained in this orifice in a position in which the clearance is essentially located on the side of the tensile stress and is so by means of a gudgeon, having a diameter smaller than the clearance, inserted in a straight end-to-end bore passing through outwardly turned edges of the safety ring and the body of the hook so that the gudgeon breaks when subjected to tensile stress greater than a predetermined threshold stress.

2) A safety hook as claimed in claim 1 wherein the safety hook is provided with a marker system enabling displacement of the safety ring following rupture of the gudgeon to be visually seen.
